(19) United States
(12) Patent Application Publication
(10) Pub. No.: US 2011/0260126 A1
(43) Pub. Date: Oct. 27, 2011

(54) WINCHING APPARATUS AND METHOD

(75) Inventor: Stewart Willis, Aberdeenshire (GB)

(73) Assignee: The Cortland Companies, Inc., Cortland, NY (US)

(21) Appl. No.: 13/140,513

(22) PCT Filed: Jul. 17, 2009
(86) PCT No.: PCT/GB2009/001775

§ 371 Date: Jun. 17, 2011

(30) Foreign Application Priority Data
Dec. 24, 2008 (GB) 0823604.4

(51) Int. Cl. B66D 1/48; B63B 27/08; B66D 1/26

(52) U.S. Cl. 254/283

(57) ABSTRACT

A winching apparatus and method for winching a load are disclosed which are particularly suitable for, though not exclusively limited to, use with heave compensated hoists or cranes, for example, on a floating structure such as a vessel. The winching apparatus comprises a first winch, a second winch, a winch line, at least one sheave or guide, a winch line cycling means and a load connection means, wherein the load is connectable to the load connection means, the winch line extends from the first winch round the at least one sheave or guide to the second winch and the winching apparatus is configured to transfer winch line between the first and second winches while the winch line cycling means cycles winch line backwards and forwards round the at least one sheave or guide.

### FIELD OF INVENTION

The present invention relates to a winching apparatus and method. The present invention is suitable for, though not exclusively limited to, use with heave compensated hoists or cranes, for example, on a floating structure such as a vessel. The invention may find use, for example, in installation of offshore structures such as wind turbines and/or nacelles therefor.

### BACKGROUND OF INVENTION

Motion compensated hoists, normally installed as part of a crane system mounted on a vessel, haul in or pay out wire rope in response to heave and roll of the vessel. Such motion compensated hoists are not, however, generally used when constructing offshore wind farms. This is because offshore wind farms generally comprise wind turbines of a uniform height and, consequently, when raising and lowering loads during construction of each wind turbine, the same parts of the wire rope pass over respective sheaves of the crane system. This may lead to rapid deterioration and early failure of the wire rope. Accordingly, motion compensation is generally not used when building offshore wind farms.

It is well known that a wind turbine generating plant is fragile. For example, a condition of warranty provided by many manufacturers of the generating plant is that a maximum acceleration of 0.5 g must not be exceeded during transport or installation of the generating plant.

In view of the above constraints, a preferred solution is to use a jack-up barge or a seabed stabilised ship when installing a nacelle of a wind turbine. The choice of vessel for such work may, therefore, be severely limited. Moreover, the availability of such vessels may be limited, imposing difficult operational constraints on and/or increasing the cost of offshore wind farm construction.

It is an object of at least one aspect of at least one embodiment of the present invention to distribute and/or reduce wear of a winch line, such as wire rope or synthetic fibre rope or the like, caused by winch line cycling around a sheave or guide for motion compensation.

It is a further object of at least one aspect of at least one embodiment of the present invention to move a winch line, such as wire rope or synthetic fibre rope or the like, past a sheave or guide of a winching apparatus while winch line is cycled backwards and forwards around the sheave or guide.

### SUMMARY OF INVENTION

According to a general solution the invention provides a means for moving winch line around a sheave or guide and a winch line cycling means for cycling winch line back and forth around the sheave or guide.

According to a first aspect of the present invention there is provided a winching apparatus comprising a first winch, a second winch, a winch line and at least one sheave or guide, wherein the winch line extends round the at least one sheave or guide along a path between the first and second winches, and the first and/or second winches is/are operable so as to move or run the winch line along the path.

According to a second aspect of the present invention there is provided a winching apparatus comprising a first winch, a second winch, a winch line, at least one sheave or guide and a winch line cycling means or device, wherein the winch line extends from the first winch round the at least one sheave or guide to the second winch and the winching apparatus is configured to transfer winch line between the first and second winches while the winch line cycling means cycles winch line backwards and forwards round the at least one sheave or guide. In a desirable implementation, the winch line cycling means is distinct and/or separate from the first and second winches.

By “while” herein may be meant at the same time as or simultaneously with. The transfer and the cycling may occur in a continuous or stepped manner. The transfer may comprise a first movement. The cycling may comprise a second movement. The transfer (first movement) and cycling (second movement) may be superimposed upon one another.

The following optional features may apply to any aspect of the present invention:

The winch line cycling means may be configured to continuously or discontinuously cycle the winch line backwards and forwards round the at least one sheave or guide but the winching apparatus is configured to transfer winch line between the first and second winches only when the winch line cycling device cycles the winch line backwards and forwards round the at least one sheave or guide.

Preferably the winching apparatus is adapted for winching a load.

The apparatus may comprise a load connection means.

The load connection means may be connectable to the load.

Use of such a winching apparatus may be advantageous because wear to the winch line caused by cycling of the winch line round the at least one sheave or guide may be at least partially distributed along the winch line as a result of the transfer of winch line between the first and second winches. Furthermore, use of such a winching apparatus may reduce wear to the winch line caused by cycling of the winch line round the at least one sheave or guide because the temperature of the winch line in the vicinity of the at least one sheave or guide may be reduced as a result of the transfer of winch line between the first and second winches.

The first and second winches may be operable to move the load connection means and any load connected to the load connection means.

The at least one sheave or guide may include at least one travelling sheave.

The travelling sheave may be connected to the load connection means.

The first and/or second winches may be operable to maintain a length of winch line between them.

The first and/or second winches may be operable to change a length of winch line between them.

The winching apparatus may be configured to transfer winch line between the first and second winches at a rate of 0.5 m/minute and 2 m/minute, e.g. around 1 m/minute.

The first and/or second winches may be operable to increase a length of winch line between the first and second winches and thereby move the load connection means and any load connected to the load connection means in a first direction.

The first and/or second winches may be operable to decrease a length of winch line between the first and second winches and thereby move the load connection means and any load connected to the load connection means in a second direction opposite the first direction.

The winch line cycling means may be operable so as to cyclically move the load connection means and any load connected to the load connection means.

The winching apparatus may comprise a controller.

The controller may be configured to control the operation of the first and second winches for the transfer of winch line between the first and second winches.

The controller may be configured to operate the first winch in a first direction and to operate the second winch in a second direction, wherein the second direction may be the same as the first direction.

The controller may be configured to operate the first winch in the first direction at the same time as operating the second winch in the second direction.

The controller may be configured to operate the first winch in a first direction at a first rate, and to operate the second winch in a second direction at a second rate, wherein the second direction is the same as the first direction and the second rate is substantially equal to the first rate so as to substantially maintain a length of winch line between the first and second winches.

The controller may be configured to operate the first and/or second winch so as to change a length of winch line between the first and second winches.

The controller may be configured to operate the first and second winches so as to change the length of winch line between them while transferring winch line between them.

The controller may be configured to operate the first winch in a first direction at a first rate. The controller may be configured to determine a second direction and a second rate by superimposing a load winching direction and a load winching rate on the first direction and the first rate. The controller may be configured to operate the second winch in the second direction at the second rate.

The controller may be configured to operate the first and second winches so as to transfer winch line between them for a first period. The controller may be configured to cease the transfer of winch line between the first and second winches for a second period. The controller may be configured to operate the first and/or second winches so as to change the length of winch line between the first and second winches during the second period.

The controller may be configured to operate the first and second winches for the first period so as to maintain a substantially constant length of winch line between them for the first period.

The controller may be configured to operate the first winch in a first direction at a first rate for the first period. The controller may be configured to operate the second winch in a second direction at a second rate for the first period wherein, the second direction may be the same as the first direction and the second rate is substantially equal to the first rate. The controller may be configured to operate the second winch in a direction different from the second direction and/or at a rate different from the second rate so as to change the length of winch line between the first and second winches during the second period.

The controller may be configured to operate the first and second winches so as to transfer winch line from the first winch to the second winch during a first interval and to transfer winch line from the second winch to the first winch during a second interval subsequent to the first interval.

The controller may be configured to operate the first and second winches so as to transfer winch line from the first winch to the second winch until a predetermined minimum length of winch line remains on the first winch and subsequently to transfer winch line from the second winch to the first winch until a predetermined minimum length of winch line remains on the second winch.

The controller may be configured to continually transfer winch line from the first winch to the second winch and back again.

The controller may be configured to operate the first and second winches so as to transfer at least part of the winch line between the first and second winches over a time period which is longer than a cycle time of the winch line cycling means. For example, the first and second winches may be operated so as to run 240 m of winch line from the first winch to the second winch over a typical time period of between 2 and 8 hours, e.g. around 4 hours. The cycle time of the winch line cycling means may typically be between 2 and 20 seconds.

The winching apparatus may comprise a winch line temperature sensor. The winch line temperature sensor may be arranged to sense a temperature of the winch line.

The controller may be adapted to receive a sensed winch line temperature value from the winch line temperature sensor.

The controller may be adapted to control the operation of the first and second winches for the transfer of winch line between the first and second winches in response to the sensed winch line temperature value.

The winch line temperature sensor may comprise an infrared sensor.

The winch line temperature sensor may comprise an imaging device.

The winching apparatus may be adapted to control the operation of the first and second winches for the transfer of winch line between the first and second winches so as to maintain a winch line temperature below a predetermined threshold temperature. For example, the controller may be adapted to control the operation of the first and second winches for the transfer of winch line between the first and second winches so as to maintain a winch line temperature below a predetermined threshold temperature.

The controller may be adapted to control the operation of the first and second winches for the transfer of winch line between the first and second winches so as to maintain the sensed winch line temperature value below a predetermined threshold temperature.

The predetermined threshold temperature may, advantageously, be less than the melting point of a lubricating medium such as grease or the like that may be internal to the winch line.

Operating the winching apparatus so as to maintain a temperature of the winch line temperature below such a predetermined threshold temperature is preferable to distribute and reduce wear of the winch line.

The winching apparatus may comprise a winch line motion sensor. The winch line motion sensor may be arranged to sense motion of the winch line.

For example, the winching apparatus may comprise a tachometer, an odometer or a revolution counter or the like operatively associated with a sheave round which the winch line runs.

The controller may be adapted to receive a sensed winch line motion value from the winch line motion sensor.

The controller may be adapted to control the operation of the first and second winches for the transfer of winch line between the first and second winches in response to the sensed winch line motion value.

The winching apparatus may comprise a winch line load sensor. The winch line load sensor may be arranged to sense winch line load.

For example, the winching apparatus may comprise a load cell. The load cell may, for example, comprise a strain gauge, or be a hydraulic or a piezo-electric load cell or the like. The load cell may measure the strain in a pin or an axle of a sheave round which the winch line runs.

The controller may be adapted to receive a sensed winch line load value from the winch line load sensor.

The controller may be adapted to control the operation of the first and second winches for the transfer of winch line between the first and second winches in response to the sensed winch line load value.

The controller may be adapted to determine a value of a property of the winch line from the sensed winch line load value and/or the sensed winch line motion value.

The controller may be adapted to control the operation of the first and second winches for the transfer of winch line between the first and second winches so as to maintain the value of the winch line property below a predetermined threshold winch line property value.

The winch line property value may be related to frictional forces acting on the winch line during motion of the winch line round the at least one sheave or guide. For example, the winch line property value may be the product of the sensed winch line motion and the sensed winch line load values. Controlling the transfer of winch line so as to maintain the winch line property value below a predetermined threshold winch line property value may, therefore, have the effect of maintaining such frictional forces below a predetermined level thereby maintaining wear of the winch line below a predetermined level.

The controller may be adapted to determine a rate of winch line wear from at least one of the sensed winch line temperature value, the sensed winch line load value and the sensed winch line motion value.

The controller may be adapted to display, indicate, communicate or otherwise notify an operator of the winch apparatus of the rate of wear caused to the winch line.

The controller may be adapted to determine a degree of winch line wear from at least one of the sensed winch line temperature value, the sensed winch line load value and the sensed winch line motion value.

The controller may be adapted to display, indicate, communicate or otherwise notify an operator of the winch apparatus of the degree of wear caused to the winch line.

The controller may be adapted to determine a time remaining for use of the winch line before a lifetime of the winch line expires from at least one of the sensed winch line temperature value, the sensed winch line load value and the sensed winch line motion value.

The controller may be adapted to display, indicate, communicate or otherwise notify an operator of the winch apparatus of the time remaining for use of the winch line before a lifetime of the winch line expires.

The winching apparatus may comprise a position and/or motion sensor. The position and/or motion sensor may be adapted to sense position and/or motion of the winching apparatus relative to an object.

The controller may be adapted to receive a value of the sensed position and/or motion from the position and/or motion sensor.

The controller may be adapted to control the operation of the winch line cycling means in response to the value of the sensed position and/or motion.

The controller may be adapted to operate the winch line cycling means so as to at least partially compensate for relative motion between an object and the load connection means or relative motion between the object and any load connected to the load connection means. This may be desirable if the winching apparatus is moving relative to the object, for example, if the winching apparatus is provided on a floating structure or vessel and the object is fixed to a seabed.

The winching apparatus may be mounted on a moving structure and the position sensor and/or motion sensor may detect movement of at least a feature of the winching apparatus. For example, a crane comprising the winching apparatus may be mounted on a moving structure and the position and/or the motion sensor may detect the position and/or motion of a feature of the crane, for example, a tip of the crane.

The position and/or motion sensor may be located close to a centre of motion of the moving structure and the position and/or motion of a feature of the winching apparatus may be determined from knowledge of the position and/or motion of the feature of the winching apparatus with respect to the centre of motion of the moving structure.

The position and/or motion sensor may comprise an existing position and/or motion sensor of the moving structure. For example, the winching apparatus may be mounted on a floating structure and the position and/or motion sensor may comprise an existing position and/or motion sensor of the floating structure. For example, the winching apparatus may be mounted on a ship and the position and/or motion sensor may comprise the ship's position and/or motion sensor.

The position and/or motion sensor may comprise an inertial sensor. The inertial sensor may detect the orientation and/or acceleration of at least a feature of the winch apparatus with respect to an inertial frame of reference. The inertial sensor may be a solid-state inertial sensor. The inertial sensor may comprise at least one gyroscope and/or at least one accelerometer. The inertial sensor may be a motion reference unit. The inertial sensor may utilise micro-electromechanical systems (MEMS) technology. For example, the inertial sensor may comprise at least one MEMS gyroscope and/or at least one MEMS accelerometer.

The position and/or motion sensor may comprise a Global Positioning System (GPS) device.

The winching apparatus may, for example, be mounted on a floating structure, and the controller may be configured to operate the winch line cycling means as a heave and/or roll compensator device for compensating for the heave and/or roll of the floating structure.

The winching apparatus may, be a hoist, crane, or, alternatively, an A-frame, derrick or the like for raising and/or lowering a load.

The winch line cycling means may be capable of cycling the load connection means and any load connected to the load connection means up and down over a distance typically associated with ocean or sea swell and/or wave heights. For example, the winch line cycling means may be capable of cycling the load connection means and any load connected to the load connection means up and down over a typical distance of up to 6 m.

The winch line cycling means may be capable of cycling the load connection means and any load connected to the load connection means up and down over a time period typically associated with ocean or sea swell and/or wave frequencies. For example, the winch line cycling means may be capable of cycling the load connection means and any load connected to the load connection means backwards and forwards at a typical frequency of up to 2000 cycles per hour.

The position and/or motion sensor may be capable of sensing acceleration of the load connection means and any load connected to the load connection means relative to an object.

The controller may be adapted to control the winch line cycling means so as to maintain the acceleration experienced by the load connection means and any load connected to the load connection means below a predetermined threshold acceleration. For example, the controller may be adapted to control the winch line cycling means so as to maintain the acceleration experienced by the load connection means and any load connected to the load connection means below 0.5 g.

The winch line may comprise at least one of a wire, cable, strand, fibre, or the like. The winch line may comprise rope such as synthetic fibre rope or wire rope or the like. The winch line may at least partially comprise a metal or metallic material. The winch line may, for example, comprise steel. The winch line may comprise a polymer or polymeric material. The winch line may comprise a cable, chain, wire or the like.

One end of the winch line may be attached to the first winch and the other end of the winch line may be attached to the second winch.

The first and/or second winches may be electrically driven and/or hydraulically driven and/or driven by an internal combustion engine or the like.

One or both of the first and/or second winches may comprise a drum winch. One or both of the first and/or second winches may comprise a traction winch. For example, one or both of the first and/or second winches may comprise a traction winch comprising an array of driven sheaves or guides and a storage drum.

The winch line cycling means may comprise a winch line cycling sheave round which the winch line extends.

The winch line cycling means may be operable so as to move the winch line cycling sheave while the winch line extends round the winch line cycling sheave.

The winch line cycling means may be operable so as to cyclically move the winch line cycling sheave.

The winch line cycling means may comprise an actuator that is operable so as to move the winch line cycling sheave.

The actuator may be hydraulically, pneumatically or electrically driven or be driven by an internal combustion engine or the like.

The actuator may comprise a piston and cylinder means.

The actuator may be operable in a first actuator direction, for example, so as to move the load connection means and any load connected to the load connection means in a first direction e.g. up or down. The actuator may, alternatively, be operated in a second actuator direction opposite the first actuator direction, for example, so as to move the load connection means and any load connected to the load connection means in a second direction opposite the first direction, e.g. down or up.

The load connection means may comprise a hook, or alternatively, a loop, gripper, fastener, clamp or the like, for example, connected to the at least one travelling sheave.

According to a third aspect of the present invention there is provided a lifting apparatus comprising at least one winching apparatus according to the first aspect of the present invention.

The lifting apparatus may be operable so as to raise and/or lower a load.

The lifting apparatus may, for example, be a hoist, a crane, or alternatively, an A-frame, derrick or the like.

According to a fourth aspect of the present invention there is provided a floating structure comprising at least one winching apparatus according to the first aspect of the present invention.

The floating structure may be a vessel such as a ship, a barge or the like. Alternatively the floating structure may be a floating platform, rig, raft or the like.

According to a fifth aspect of the present invention there is provided a method of winching or lifting and/or lowering a load, the method comprising:

providing a winching apparatus according to the first aspect of the present invention; and

using the apparatus to winch a load.

The step of using the apparatus to winch a load may comprise using the apparatus to lift and/or lower a load.

The step of providing the winching apparatus may comprise providing the winching apparatus on a floating or floatable structure.

The load may comprise a part of a wind turbine, for example, a nacelle.

According to a sixth aspect of the present invention there is provided a method of operating a winching apparatus having a first winch, a second winch, a winch line, at least one sheave or guide and a winch line cycling means, wherein the winch line extends from the first winch round the at least one sheave or guide to the second winch and the method comprises:

operating the first and second winches so as to transfer winch line therebetween while operating the winch line cycling means so as to cycle winch line backwards and forwards round the at least one sheave or guide.

The method may comprise operating the first winch in a first direction and operating the second winch in a second direction wherein the second direction is the same as the first direction.

The method may comprise operating the first winch in the first direction at the same time as operating the second winch in the second direction.

The method may comprise:

operating the first winch in a first direction at a first rate; and

operating the second winch in a second direction at a second rate wherein the second direction is the same as the first direction and the second rate is substantially equal to the first rate so as to substantially maintain a length of winch line between the first and second winches.

The method may comprise operating the first and second winches so as to change a length of winch line between them.

The method may comprise operating the first and second winches so as to change the length of winch line between them while transferring winch line between them.

The method may comprise:

operating the first winch in a first direction at a first rate;

determining a second direction and a second rate by superimposing a load winching direction and a load winching rate on the first direction and the first rate; and

operating the second winch in the second direction at the second rate.

The method may comprise:

operating the first and second winches so as to transfer winch line between them for a first period;

ceasing the transfer of winch line between the first and second winches for a second period; and

operating the first and/or second winches so as to change the length of winch line between the first and second winches during the second period.

The method may comprise operating the first and second winches for the first period so as to maintain a substantially constant length of winch line between them for the first period.

The method may comprise:

operating the first winch in a first direction at a first rate for the first period;

operating the second winch in a second direction at a second rate for the first period wherein the second direction is the same as the first direction and the second rate is substantially equal to the first rate; and

operating the second winch in a direction different from the second direction and/or at a rate different from the second rate so as to change the length of winch line between the first and second winches during the second period.

The method may comprise:

operating the first and second winches so as to transfer winch line from the first winch to the second winch during a first interval; and then

operating the first and second winches so as to transfer winch line from the second winch to the first winch during a second interval subsequent to the first interval.

The method may comprise:

operating the first and second winches so as to transfer winch line from the first winch to the second winch until a predetermined minimum length of winch line remains on the first winch; and subsequently

operating the first and second winches so as to transfer winch line from the second winch to the first winch until a predetermined minimum length of winch line remains on the second winch.

The method may comprise continually transferring winch line from the first winch to the second winch and back again.

The method may comprise operating the first and second winches so as to transfer at least part of the winch line between the first and second winches over a time period which is longer than a cycle time of the winch line cycling means.

The method may comprise:

sensing a temperature of the winch line; and

controlling the transfer of winch line between the first and second winches in response to the sensed temperature of the winch line.

The method may comprise controlling the transfer of winch line between the first and second winches so as to maintain a winch line temperature below a predetermined threshold temperature.

The method may comprise controlling the transfer of winch line between the first and second winches so as to maintain the sensed winch line temperature below the predetermined threshold temperature.

The method may comprise:

sensing motion of the winch line; and

controlling the transfer of winch line between the first and second winches in response to a sensed motion value of the winch line.

The method may comprise:

sensing winch line load; and

controlling the transfer of winch line between the first and second winches in response to a sensed motion value of the winch line load.

The method may comprise determining a winch line property value from the sensed values of the winch line motion and the winch line load.

The method may comprise controlling the transfer of winch line between the first and second winches so as to maintain the winch line property value below a predetermined threshold winch line property value.

According to a seventh aspect of the present invention there is provided a method of prolonging a lifetime of a winch line which runs cyclically round a sheave or guide, the method comprising cyclically running different portions of the winch line round the sheave or guide at different times.

### BRIEF DESCRIPTION OF DRAWINGS

Embodiments of the present invention will now be described by way of non-limiting example only with reference to the following drawings which are:

FIG. 1 a winching apparatus according to a first embodiment of the present invention;

FIG. 2 an illustration of operation of a winch line cycling means of the winching apparatus of FIG. 1;

FIG. 3 a vessel comprising the winching apparatus of FIG. 1 in use lowering a load towards a post structure comprising part of a wind turbine secured to the seabed;

FIG. 4 a portion of a winch cable of the winching apparatus of FIG. 1 in the vicinity of a sheave; and

FIG. 5 the winching apparatus of FIG. 1 including various sensors and a controller.

### DETAILED DESCRIPTION OF DRAWINGS

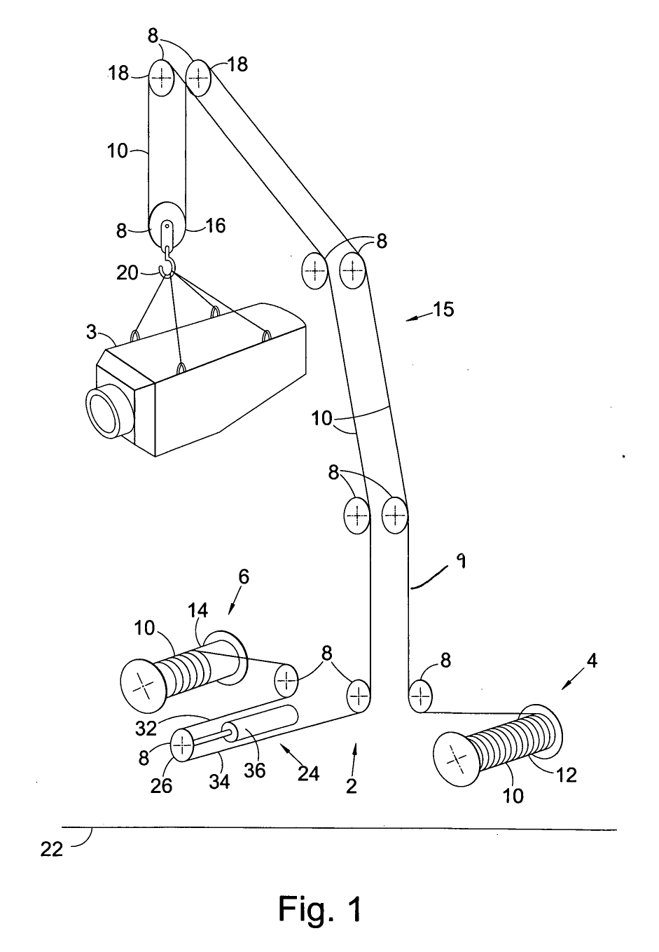

Referring initially to FIG. 1 there is shown a crane comprising a winching apparatus, generally designated 2, lifting a load 3, for example, in the form of a nacelle of a wind turbine. The winching apparatus 2 comprises a first electrically driven drum winch 4, a second electrical driven driven drum winch 6, a series of sheaves or guides 8 and a winch line 9 in the form of a wire rope 10 or alternatively a synthetic fibre rope or the like. The wire rope 10 is attached at one end to the first winch 4. Part of the wire rope 10 is wound around a drum portion 12 of the first winch 4. The other end of the wire rope 10 is attached to the second winch 6. Part of the wire rope 10 is wound around a drum portion 14 of the second winch 6. Between the first and second winches 4,6 the wire rope 10 extends round the series of sheaves in a twin fall configuration 15 that extends upwards along a crane structure (not shown). The series of sheaves 8 includes a travelling sheave 16 suspended via the wire rope 10 from a pair of sheaves 18 located at an end of a crane boom (not shown). Connected to the travelling sheave 16 is a load connection means in the form of a hook 20 from which the load 3 is suspended.

The first and second winches 4,6 are controllable so as to rotate in a respective direction and/or at a respective rate to maintain the position (height) of hook 20 and the load 3 relative to (above) a surface 22 upon which the winching apparatus 2 is mounted and to raise and lower the hook 20 and the load 3 above the surface 22. For example, to maintain the hook 20 and the load 3 in a selected position, the first winch 4 is operated to pay out wire rope 10 at the same rate as the second winch 6 hauls in wire rope 10, or vice versa. To raise the hook 20 and the load 3, the first and second winches 4,6 are both operated to haul in wire rope 10 or one of the first and second winches 4,6 is operated to haul in at a rate faster than the other winch 6,4 pays out. To lower the hook 20 and the load 3, the first and second winches 4,6 are both operated to pay out wire rope 10 or one of the first and second winches 4,6 is operated to pay out at a rate faster than the other winch 6,4 hauls in.

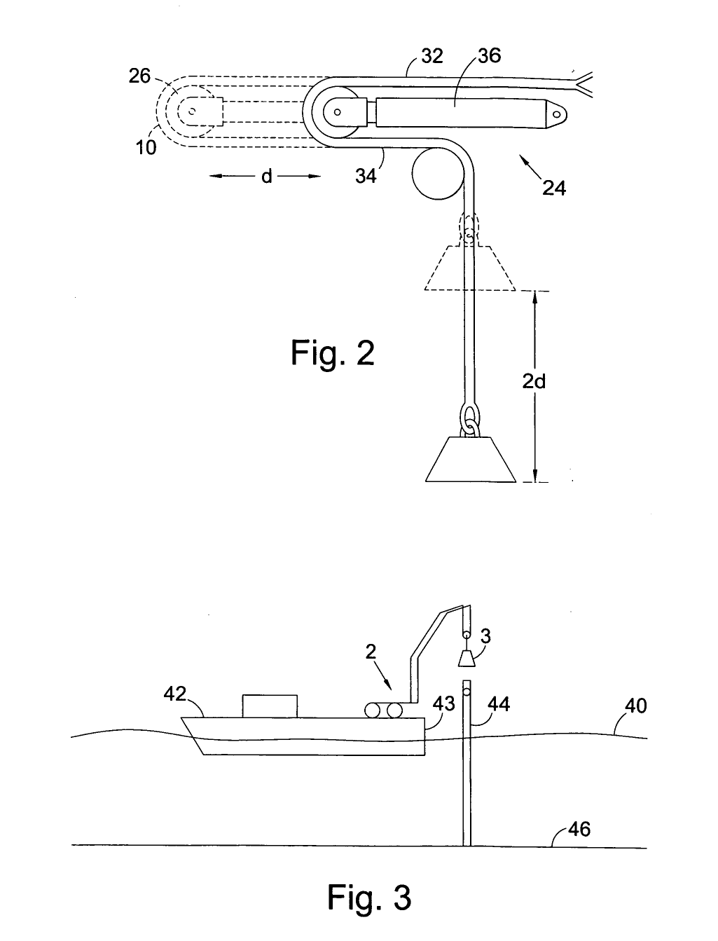

The winching apparatus 2 further comprises a winch line cycling means in the form of a heave compensator 24. The heave compensator 24 comprises a heave compensator sheave 26 round which the wire rope 10 passes. The heave compensator sheave 26 is positioned along the wire rope between the second winch 6 and the twin fall arrangement 15 so as to route the wire rope 10 along a detour path comprising two detour path arms 32 and 34. The heave compensator 24 further comprises a hydraulic ram 36 which is connected to the heave compensator sheave 26. The hydraulic ram 36 is operable so as to translate the heave compensator sheave 26 horizontally and thereby increase or decrease the length of the detour path. When one of the first and second winches 4,6 is paying out at the same rate as the other of the first and second winches 6,4 is hauling in, translation of the heave compensator sheave 26 alters the length of the wire rope extending between the heave compensator 24 and the first winch 4. As illustrated in FIG. 2, for example, translating the heave compensator sheave 26 by a distance d has the effect of translating the wire rope 10 by around a distance 2d. Correspondingly, due to the twin fall arrangement 15, the hook 20 and/or the load 3 are raised or lowered by an amount d.

In use, the heave compensator 24 is operable so as to at least partially compensate for the rise and fall associated with water level e.g. ocean or sea waves and/or swells 40 as shown in FIG. 3. In FIG. 3, the crane comprising the winch apparatus 2 is shown mounted on a deck of a vessel in the form of a ship 42 in the vicinity of a stern 43 of the ship 42. The crane is shown lifting a nacelle 3 of an offshore wind turbine from the stern 43 of the ship 42 and lowering such towards a tower 44 of an offshore wind turbine which is fixed to a seabed 46. As the ship 42 rises and falls, the heave compensator 24 continually lowers and raises the nacelle 3 respectively by a corresponding amount respectively so as to maintain the nacelle 3 at a fixed height relative to the tower 44. Typically for a 5 MW offshore wind turbine the nacelle 3 may weigh approximately 400 tonnes and the tower 44 may extend approximately 95 m above mean sea level. Accordingly, the crane comprising the winch apparatus 2 is capable of lifting a 530 tonne dynamic load or a 440 tonne static load to a maximum height of 120 m above a deck of the ship 42. Furthermore, the wire rope 10 has a diameter of 96 mm.

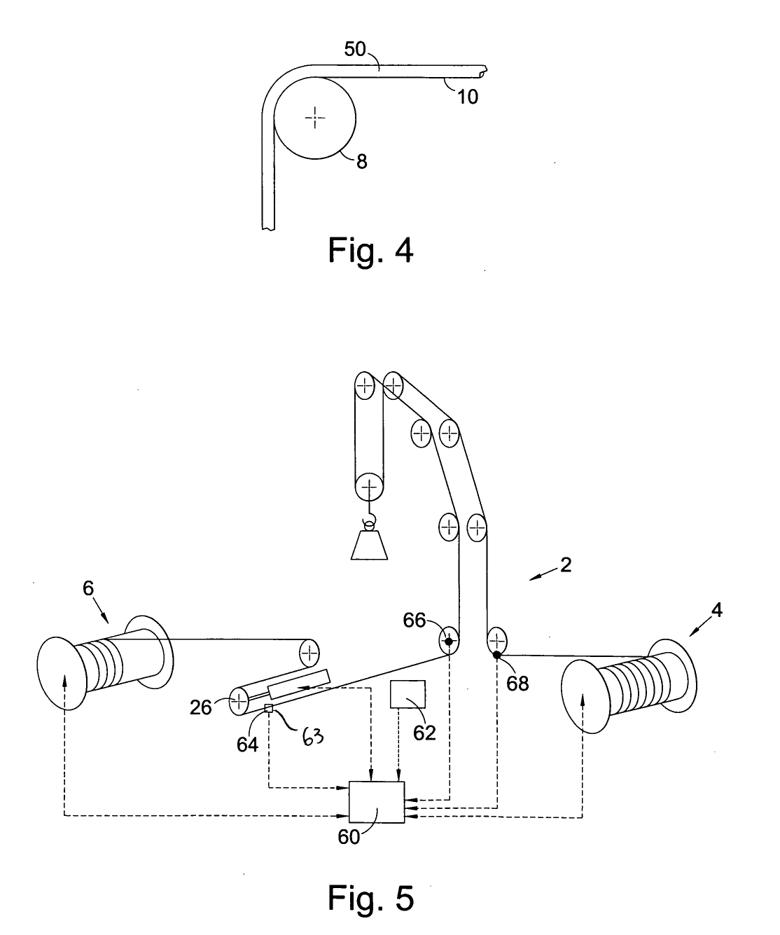

As shown in FIG. 4, during heave compensation, a portion 50 of the wire rope 10 is subject to bending as the portion 50 runs or is passed round a respective sheave 8 leading to localised heating and wear of the portion 50. To distribute and reduce the heating and wear of the wire rope 10 during operation of the heave compensator 24, therefore, the first and second winches 4,6 are operated so as to transfer wire rope 10 between them. For example, if the nacelle 3 is to be held at a fixed height relative to the tower 44 by the action of the heave compensator 24, the first winch 4 may be operated to pay out wire rope 10 and the second winch 6 may be operated to haul in wire rope 10 at the same rate at which the first winch 4 pays out. This has the effect of moving portion 50 of the wire rope 10 away from the sheave 8 shown in FIG. 4. For typical ocean or sea wave or swell heights that vary by up to 6 m over a cycle time of the order of 10 s, the rate at which the wire rope 10 is transferred between the first and second winches 4,6 is of the order of 1 m per minute. Thus, for the example of a 6 m swell height, a 6 m portion 50 of wire rope 10 runs backwards and forwards round the sheave 8 under the action of the heave compensator 24. After a period of 6 minutes, however, none of the same 6 m portion 50 of wire rope 10 runs round the sheave 8. Transferring the wire rope 10 between the first and second winches 4,6 has the effect of distributing wear along the length of the wire rope 10. In addition, because localised temperatures along the wire rope 10 in the vicinity of the sheaves 8 are also reduced, wear of the wire rope 10 is actually reduced.

Subsequently, to raise the nacelle 3 relative to the tower 44, the second winch 6 may continue to haul in at the same rate while the first winch 4 may pay out wire rope 10 more slowly or haul in wire rope 10. To lower the nacelle 3 relative to the tower 44, the second winch 6 may continue to haul in wire rope 10 at the same rate while the first winch 4 may pay out wire rope 10 more quickly. Thus, the rate at which the first winch 4 pays out wire rope 10 for the transfer of wire rope 10 to the second winch 6 is modified so as to superimpose any motion of the wire rope 10 necessary to raise or lower the nacelle 3 while the second winch 6 continues to haul in wire rope 10 at a substantially constant rate.

The first and second winches 4,6 are operated so as to transfer the wire rope 10 from the first winch 4 to the second winch 6 until a minimum length of wire rope 10 is available at the first winch 4 wherein the minimum length is sufficient to permit raising and lowering of the load 3 through the full 120 m lifting range if necessary. Subsequently, the first and second winches 4,6 are operated so as to transfer the wire rope 10 from the second winch 6 back to the first winch 4 until the minimum length of wire rope 10 is available at the second winch 6 and this process is repeated so that the wire rope 10 is continuously transferred between the first and second winches 4,6.

FIG. 5 is a schematic illustration of the winching apparatus 2 of FIG. 1 including various sensors and a controller 60. As shown in FIG. 5, the winching apparatus 2 further comprises a motion sensor in the form of a motion reference unit 62 which is secured to the ship 42. Such a motion reference unit 62 comprises at least one accelerometer, for example, at least one MEMS accelerometer and at least one gyroscope, for example, at least one MEMS gyroscope. As indicated by the dashed lines, the controller 60 receives a signal from the motion reference unit 62 and, in response, the controller 60 controls the hydraulic ram 36 to adjust the height of the hook 20 and the load 3 so as to at least partially compensate for the heave and/or roll of the ship 42.

The winching apparatus 2 further comprises a winch line temperature sensor 63 in the form of an infrared imaging device 64 for sensing a temperature of the wire rope 10. The infrared imaging device 64 is located in the detour path arm 34 in the vicinity of the heave compensator sheave 26. The controller 60 receives a signal from the infrared imaging device 64 and, in response, the controller 60 controls the winching rates of the first and/or second winches 4,6 so as to alter a rate of transfer of the wire rope 10 between the first and second winches 4,6 so as to avoid a temperature of the wire rope 10 in the vicinity of the infrared imaging device 64 from exceeding a predetermined maximum threshold temperature. In particular, the controller 60 controls the first and second winches 4,6 so as to maintain the temperature of the wire rope 10 in the vicinity of the infrared imaging device 64 from exceeding a melting point of any grease internal to the wire rope 10. This has the effect of mitigating excessive wear of the wire rope 10.

The winching apparatus 2 further comprises a winch line load sensor in the form of a load measuring sheave pin 66 comprising a strain gauge. In addition, the winching apparatus 2 comprises a winch line motion sensor in the form of a revolution counting device 68. The controller 60 receives signals from the load measuring sheave pin 66 and the revolution counting device 68. The controller calculates cumulative stress data associated with the wire rope 10 from at least one of the winch line temperature sensor, the winch line load sensor and the winch line motion sensor. The controller 60 further calculates a time remaining for use of the wire rope 10 before a lifetime of the wire rope 10 expires.

It should be understood that the embodiments described herein are merely exemplary and that various modifications may be made without departing from the scope of the present invention.

For example, one or both of the first and second drum winches may be hydraulically driven.

In an alternative and advantageous modification to the disclosed embodiment, rather than continuously transferring the wire rope 10 from one of the first and second winches 4, 6 to the other, the wire rope 10 may be transferred in a discontinuous fashion. The transfer of the wire rope 10 may, for example, be conducted in discrete steps.

In a further modification to the disclosed embodiment, the controller 60 is adapted to determine a winch line property value, which winch line property value is related to frictional forces acting on the wire rope 10 during motion of the wire rope 10 round the at least one sheave or guide 8. For example, the winch line property value may be the product of the sensed winch line motion and the sensed winch line load values. The controller 60 may be adapted to control the rate of transfer of the wire rope 10 between the first and second winches 4,6 so as to maintain the winch line property value below a predetermined maximum winch line property value.

In another modification to the disclosed embodiment, one or both of the first and second drum winches 4,6 shown in FIG. 1 may be replaced by a traction winch arrangement comprising a traction winch and a storage drum. It will be understood by one skilled in the art that in such a traction winch arrangement the traction winch pays out and/or hauls in wire rope 10 under load while only a nominal tension exists between the traction winch and the storage drum. The traction winch may, for example, comprise an array of driven sheaves and a storage drum.

1. A winching apparatus comprising a first winch, a second winch, a winch line, at least one sheave or guide and a winch line cycling means, wherein the winch line extends from the first winch round the at least one sheave or guide to the second winch and the winching apparatus is configured to transfer winch line between the first and second winches while the winch line cycling means cycles winch line backwards and forwards round the at least one sheave or guide, and wherein the winching apparatus further includes at least one sensor configured to indicate a characteristic of the winch line associated with mitigating wear of the winch line.

2. The winching apparatus as claimed in claim 1 wherein the winching apparatus is adapted to winch a load.

3-32. (canceled)

33. The winching apparatus as claimed in claim 1, wherein the sensor is a winch line motion sensor is arranged to sense a motion of the winch line.

34. The winching apparatus as claimed in claim 33, further comprising a controller adapted to receive a value of the sensed winch line motion from the winch line motion sensor and the controller is adapted to control the operation of the first and second winches for the transfer of winch line between the first and second winches in response to the value of the sensed winch line motion.

35. The winching apparatus as claimed in claim 1, wherein the sensor is a winch line load sensor arranged to sense winch line load.

36. The winching apparatus as claimed in claim 35, further comprising a controller adapted to receive a sensed winch line load value from the winch line load sensor and the controller is adapted to control the operation of the first and second winches for the transfer of winch line between the first and second winches in response to the value of the sensed winch line load.

37-55. (canceled)

56. A method of operating a winching apparatus having a first winch, a second winch, a winch line, at least one sheave or guide and a winch line cycling means, wherein the winch line extends from the first winch round the at least one sheave or guide to the second winch and the method comprises the step of:
operating the first and second winches so as to transfer winch line therebetween while operating the winch line cycling means so as to cycle winch line backwards and forwards round the at least one sheave or guide.

57-63. (canceled)

64. The method as claimed in claim 56, further comprising the steps of:
operating the first winch at a first rate; and
operating the second winch at a second rate wherein the second rate is substantially equal to the first rate so as to substantially maintain a length of winch line between the first and second winches.

65. The method as claimed in claim 56, further comprising the step of:
operating the first and second winches so as to change a length of winch line between them.

66. The method as claimed in claim 56, further comprising the step of:
operating the first and second winches so as to change the length of winch line between them while transferring winch line between them.

67-73. (canceled)

74. The method as claimed in claim 56, further comprising the step of:
operating the first and second winches so as to transfer at least part of the winch line between the first and second winches over a time period which is longer than a cycle time of the winch line cycling means.

75-81. (canceled)

82. A winching apparatus comprising a first winch, a second winch, a winch line, at least one sheave or guide and a winch line cycling means, wherein the winch line extends from the first winch round the at least one sheave or guide to the second winch and the winching apparatus is configured to transfer winch line between the first and second winches while the winch line cycling means cycles winch line backwards and forwards round the at least one sheave or guide, and wherein the winching apparatus further includes at least one sensor configured to indicate a characteristic of the winch line associated with cumulative stress.

83. The winching apparatus as claimed in claim 82, wherein the winch line is synthetic fibre rope or wire rope.

84. The winching apparatus as claimed in claim 82, wherein the sensor is a winch line motion position sensor arranged to sense a movement and position of at least a feature of the winching apparatus.

85. The winching apparatus as claimed in claim 82, wherein the sensor is a winch line load sensor arranged to sense winch line load.

86. The winching apparatus as claimed in claim 85, further comprising a controller adapted to receive a sensed winch line load value from the winch line load sensor and the controller is adapted to control the operation of the first and second winches for the transfer of winch line between the first and second winches in response to the value of the sensed winch line load.

87. A winching apparatus comprising a first winch, a second winch, a winch line and at least one sheave or guide, wherein the winch line extends round the at least one sheave or guide along a path between the first and second winches, and the first and/or second winches is/are operable so as to move or run the winch line along the path, wherein the winching apparatus further comprises a winch line temperature sensor.

88. The winching apparatus as claimed in claim 87, further comprising a controller adapted to receive a value of the sensed winch line temperature from the winch line temperature sensor and the controller is adapted to control the operation of the first and second winches for the transfer of winch line between the first and second winches in response to the value of the sensed winch line temperature.

89. The winching apparatus as claimed in claim 87, wherein the winch line temperature sensor is an infrared sensor.

90. The winching apparatus as claimed in claim 87, further comprising a controller adapted to control the operation of the first and second winches for the transfer of winch line between the first and second winches so as to maintain a winch line temperature below a predetermine
